(19) United States
(12) Patent Application Publication
(10) Pub. No.: US 2012/0147901 A1
(43) Pub. Date: Jun. 14, 2012

(54) COMPACTED BINARY IDENTIFIER GENERATION

(75) Inventors: Claude Basso, RESEARCH TRIANGLE PARK, NC (US); Jean L. Calvignac, Raleigh, NC (US); Natarajan Vaidhyanathan, RESEARCH TRIANGLE PARK, NC (US); Fabrice Verplanken, LaGaude (FR)

(73) Assignee: INTERNATIONAL BUSINESS MACHINES CORPORATION, Armonk, NY (US)

(21) Appl. No.: 13/325,553

(22) Filed: Dec. 14, 2011

(30) Foreign Application Priority Data
Dec. 14, 2010 (EP) 10306404

(51) Int. Cl. H04L 12/00; H04J 3/00

(52) U.S. Cl. 370/474; 370/476

(57) ABSTRACT

A technique for generating a compacted binary identifier includes breaking an original binary identifier into equal parts. Each bit of a first one of the parts is exclusive ORed with a start-up value to generate a first result. Each bit of the first result is exclusive ORed with a respective bit of a second one of the parts to generate a second result.

This application claims priority to European Patent Application No. EP10306404, entitled “COMPACTION OF A BINARY IDENTIFIER,” filed Dec. 14, 2010, the disclosure of which is hereby incorporated herein by reference in its entirety.

### CROSS-REFERENCE TO RELATED APPLICATIONS

The present application is related to the following commonly assigned patent applications: U.S. patent application Ser. No. ______ (Attorney Docket No. FR920100060US1), entitled “ANALYSIS OF NETWORK PACKETS USING A GENERATED HASH CODE” by Claude Basso et al.; and U.S. patent application Ser. No. ______ (Attorney Docket No. FR920100061US1), entitled “BIDIRECTIONAL PACKET FLOW TRANSFORMATION” by Claude Basso et al., all of which were filed on even data herewith and are incorporated herein by reference in their entirety for all purposes.

### BACKGROUND

1. Field

This disclosure relates generally to generation of a compacted binary identifier and, more specifically, to generation of compacted Internet Protocol version 6 (IPv6) addresses.

2. Related Art

Internet Protocol version 4 (IPv4) defines the addressing capabilities of the Internet in its original form with 32-bit addresses, which provides a total of 2³² or about 4.3 billion possible addresses. The explosive growth and worldwide proliferation of networks has meant that all available addresses under IPv4 are expected to be exhausted by 2012. Accordingly, Internet Protocol version 6 (IPv6) has been defined to replace IPv4 to addresses certain shortcomings of IPv4. In particular, IPv6 specifies 128-bit addresses for a theoretical capacity of 3.4×10³⁸ addresses.

### SUMMARY

A technique for generating a compacted binary identifier includes breaking an original binary identifier into equal parts. Each bit of a first one of the parts is exclusive ORed with a start-up value to generate a first result. Each bit of the first result is then exclusive ORed with a respective bit of a second one of the parts to generate a second result.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of a relevant portion of an exemplary hasher that may be implemented in a network processor configured according to various aspects of the present disclosure.

FIG. 2 is a diagram of a relevant portion of an exemplary standard hasher input structure according to one or more embodiments of the present disclosure.

FIG. 3 is a diagram of relevant components of an exemplary compaction array configured according to aspects of the present disclosure.

FIG. 4 is a flowchart of an exemplary process for compacting a binary identifier according to one aspect of the present disclosure.

FIG. 5 is a diagram depicting relevant portions of an exemplary IPv6 packet encapsulated in an Ethernet packet according to yet another aspect of the present disclosure.

FIG. 6 is a flowchart of an exemplary process (implemented by a parser control module) to support data processing according to a different aspect of the present disclosure.

### DETAILED DESCRIPTION

As will be appreciated by one of ordinary skill in the art, the present invention may be embodied as a method, system, device, or computer program product. Accordingly, the present invention may take the form of an embodiment including hardware, an embodiment including software (including firmware, resident software, microcode, etc.) or an embodiment combining software and hardware aspects that may all generally be referred to herein as a circuit, module, or system. The present invention may, for example, take the form of a computer program product on a computer-usable storage medium having computer-usable program code, e.g., in the form of one or more design files, embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include: a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. As used herein the term “coupled” includes a direct electrical connection between elements or blocks and an indirect electrical connection between elements or blocks achieved using one or more intervening elements or blocks.

According to aspects of the present disclosure, compaction of relatively large (16-byte) IPv6 addresses into regular (4-byte) address fields is performed while preserving the properties required for a hash key. The compaction utilizes cumulative exclusive OR (XOR) based prehashing of 4-bytes at a time. Compaction of 4-bytes at a time advantageously minimizes the logic and silicon area required to support IPv6 addresses, for example, in a hasher that accepts keys like ‘5-tuples’. In the case of a 5-tuple, hash keys are assembled with five fields extracted from packet headers that are representative of a packet flow to which an associated packet belongs. A typical example of a 5-tuple used to identify transmission control protocol (TCP) connections includes: an IP source address (IP SA); an IP destination address (IP DA); a protocol byte (Prot); a TCP source port (TCP SP); and a TCP destination port (TCP DP).

It should be appreciated that an implementation problem may occur when a packet has an IPv6 layer 3 (L3) header. For example, while IPv4 headers have 4-byte IP addresses, IPv6 headers have 16-byte IP addresses. As such, a 5-tuple key for an IPv6 header is much larger than an IPv4 header. For example, a 5-tuple key for an IPv4 header includes thirteen bytes (i.e., IPv4=IP SA(4 bytes)+IP DA(4 bytes)+protocol(1 byte)+TCP SP(2 bytes)+TCP DP(2 bytes)=13 bytes) while a 5-tuple key for an IPv6 header includes thirty-seven bytes (i.e., IPv6=IP SA(16 bytes)+IP DA(16 bytes)+protocol(1 byte)+TCP SP(2 bytes)+TCP DP(2 bytes)=37 bytes).

Implementing a hasher with a 37-byte input register is usually more expensive in silicon area due to, for example, the one-hundred ninety-two (24×8=192) additional latches required to hold the larger IPv6 addresses and the larger combinatorial cone of logic originating at 37×8=296 versus 13×8=104 inputs. Since the size of the cone of logic constituting a hasher is not linear with the number of hasher inputs, the area ratio between the two implementations is at least four times. According to the present disclosure, IPv6 addresses are pre-processed to reduce IPv6 addresses to the IPv4 address size in order to utilize the same key input registers and logic cone for IPv6 and IPv4 addresses.

According to the present disclosure, a compacted binary identifier (e.g., a compacted IPv6 address) is generated such that the same key input registers and logic cone may be utilized for both IPv6 and IPv4 addresses. In general, the disclosed compaction process is non-deterministic. That is, a number of different binary identifiers can produce the same compacted identifier and, as such, it is not possible to reconstitute an original binary identifier from a compacted identifier. While this property may rule out the use of a compacted identifier in certain applications there are, nevertheless, many applications in which a compacted identifier is satisfactory. More particularly, the disclosed approach is suitable for many applications where it is desired to characterise packets or other data on the basis of identity information without that characterisation being granular to the level of unique identities. Examples of such applications include packet identifiers and IP filters. As mentioned above, the disclosed approach is particularly useful for a hash function, e.g., a hash function that identifies packet flows in a network processor.

The flexibility of hash functions are typically defined by two properties: the way in which the hash key is assembled; and the properties of the hash function. Several trade-offs are often made to implement flexible hashers by playing on variations of the two properties. Traditionally, flexibility in hash key assembly is achieved in software implementations of hashers, while flexible hash functions usually involve some form of configurable hardware hasher implementation. Each aspect of hasher flexibility typically has limitations. For example, software hash key assemblies have performance limitations when complex patterns are required to build the hash key (in particular, when the key assembly is done at bit-level granularity). As another example, configurable hardware hash functions have silicon area limitations due to configuration logic implementing the base hashing elements (which are typically implemented with XOR gates). The foregoing limitations appear to be especially significant when a hasher is used for identifying packet flows on high-speed interfaces (e.g., 10 Gbps or more), mainly because of the very short packet periodicity (e.g., 67.2 ns or less).

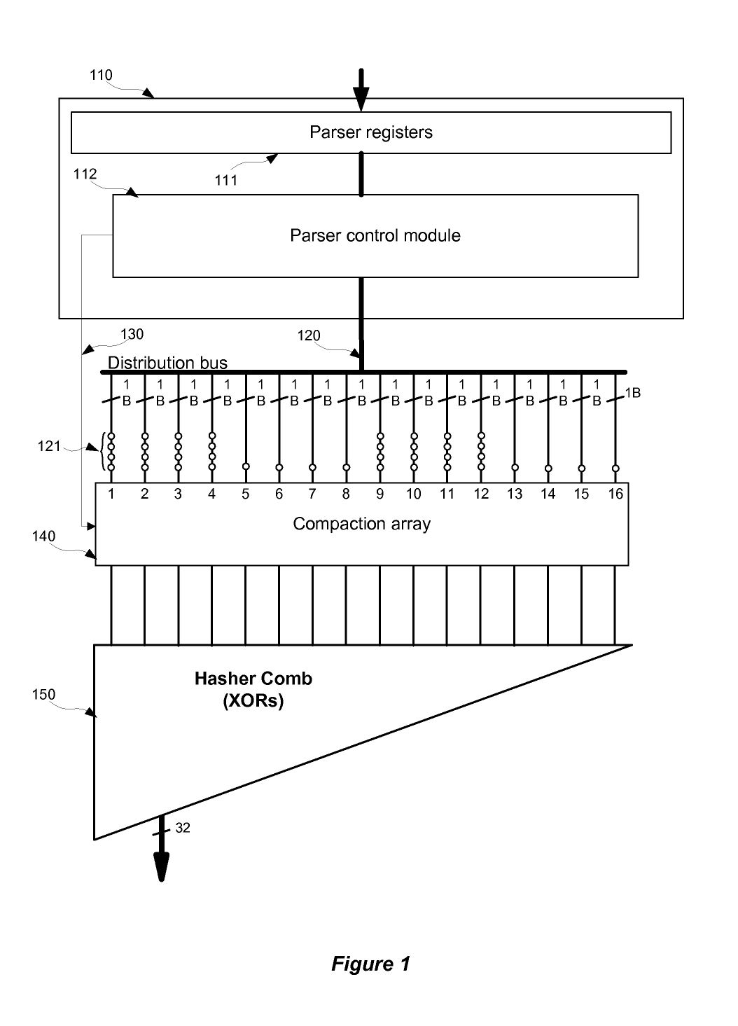

FIG. 1 shows a relevant portion of an exemplary hasher (of a network processor) that is configured according to one embodiment. The role of the hasher in the network processor is to produce a value that facilitates the identification of a packet to a degree of granularity to permit the assignment of the packet to a particular receive or transmit queue, such that like packets are assigned to the same queue. As shown, the hasher includes a parser 110, a distribution bus 120, a reset line 130, a compaction array 140, and a hasher combinatorial cone (hasher comb) 150. Parser 110 receives packets which are loaded into parser registers 111. Parser 110 examines the content of registers 111 and, on the basis of knowledge concerning possible packet formats and the values found at particular positions in the packet (in particular in a header portion of the packet), identifies the positions of certain key pieces of information and extracts the information as required. In general, the extracted information is helpful in uniquely identifying the network communication to which the packet belongs.

Flexibility for hash key assembly is achieved through distribution bus 120. Distribution bus 120 can fill any input of compaction array 140 byte-wise from parser 110, which may, for example, be implemented as a pico-coded finite state machine (FSM). In this manner, raw keys with any combinations of bytes extracted from the packet by parser 110 may be assembled. The input stages of compaction array 140 (and by the same token the hasher combinatorial cone 150) include a set of 16-byte wide registers that are individually addressable in order to be loaded by any packet parser capable of extracting bytes from packet headers and/or payloads. The order in which the various bytes are loaded is determined by the amount of information included in each extracted byte that can contribute to the flow identification.

The hash function implemented by hasher combinatorial cone 150 is a classical combinatorial cone of logic based on XOR gates that combine all 128-bits of a hash key and produce a resulting 32-bit hash value. Compaction array 140 implements a compaction feature that minimizes the size of the key assembly area (and conversely the silicon area of the hardware hash function receiving the key) by reducing long elements of the key into smaller fields. A typical application is the reduction of 16-byte address fields in IPv6 headers into 4-byte elements that can use the same input registers as the 4-byte addresses extracted from IPv4 headers. As mentioned above, depending on the circumstances, the specific pieces of information that are available (for the construction of the key and which may be desirable to use as inputs to hasher combinatorial cone 150 ) vary.

For example, information available for key construction may include various scenarios, e.g., a 5-tuple format, a 3-tuple format, a 2-tuple format, a multi-protocol label switching (MPLS) 1 format, an MPLS 2 format, and a tunnelled IP-in-IP packet format. The designation and sizes of the various scenario are illustrated in the tables below:

### 5-Tuple:

| | | |
|---|---|---|
| SA | Source Address | 4 Bytes |
| SP | Source Port | 2 Bytes |
| DA | Destination Address | 4 Bytes |
| DP | Destination Port | 2 Bytes |
| Proto | Protocol | 1 Byte |

### 3-Tuple

| | | |
|---|---|---|
| DA | Destination Address | 4 Bytes |
| DP | Destination Port | 2 Bytes |
| Proto | Protocol | 1 Byte |

### 2-Tuple

| | | |
|---|---|---|
| DP | Destination Port | 2 Bytes |
| Proto | Protocol | 1 Byte |

### MPLS 1

| | | |
|---|---|---|
| Label | | 2.5 Bytes |
| SA | Source Address | 4 Bytes |
| SP | Source Port | 2 Bytes |
| DA | Destination Address | 4 Bytes |
| DP | Destination Port | 2 Bytes |
| Proto | Protocol | 1 Byte |

### MPLS 2

| | |
|---|---|
| Label | 2.5 Bytes |

Tunnelled IP-in-IP packets

| | | |
|---|---|---|
| SA (1) | Inner packet Source Address | 4 Bytes |
| SP (1) | Inner packet Source Port | 2 Bytes |
| DA (1) | Inner packet Destination Address | 4 Bytes |
| DP (1) | Inner packet Destination Port | 2 Bytes |
| Proto (1) | Inner packet Protocol | 1 Byte |
| SA (2) | Outer packet Source Address | 4 Bytes |
| DA (2) | Outer packet Destination Address | 4 Bytes |

Depending on the situation, parser control module 112 extracts the various components of the packet in registers 111 that are required to complete a dataset and sends each component to a respective input of compaction array 140. In accordance with at least one embodiment, parser control module 112 maps the information extracted from a packet, in accordance with the scenarios listed above, onto a standard hasher input structure.

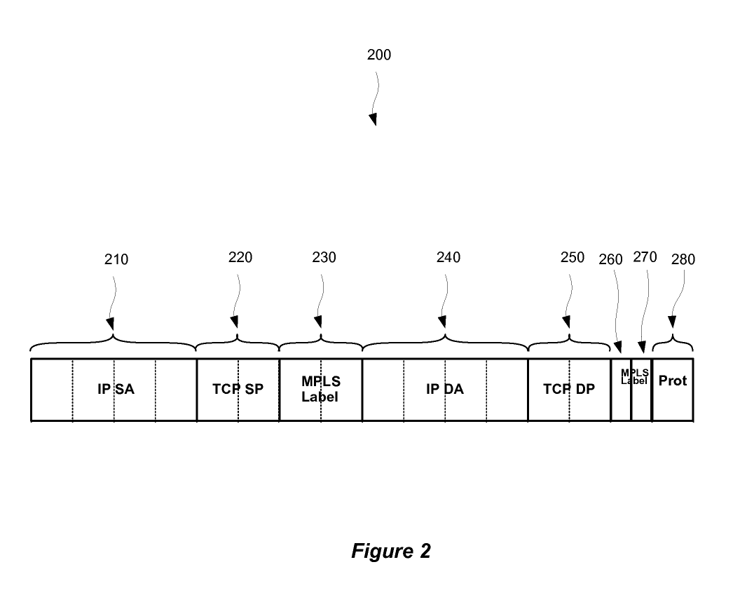

FIG. 2 shows a standard hasher input structure 200, which includes 16-bytes. A first section 210, which includes four bytes, is used for IP source addresses (IP SA). A second section 220, which includes two bytes, is used for TCP source port (TCP SP) values. A third section 230, which includes two bytes, is used for MPLS label values. A fourth section 240, which includes four bytes, is used for IP destination addresses (IP DA). A fifth section 250, which includes two bytes, is used for TCP destination port (TCP DP) values. A sixth section 260, which includes four bits, is used for MPLS label values in conjunction with third section 230. A seventh section 270, which includes four bits, is reserved. An eighth section 280, which includes one byte, is used for protocol (Prot) values.

It should be appreciated that in other embodiments different structures may be used, or a structure may not be defined, in which case parser control module 112 may simply retain data in the order the data is extracted from a packet, as long as it is reassembled in a set of back-to-back fields. In one or more embodiments, compaction array 140 may only intercept values for the first to fourth and ninth to twelfth bytes, since these are the only bytes which are needed to handle IPv6 addresses. In general, however, compaction array 140 should provide compaction modules for every input of hasher combinatorial cone 150 so as to allow full flexibility in the assignment of data to different inputs. Compaction array 140 has a number of data inputs and a number of outputs equal to the number of inputs of hasher combinatorial cone 150. As shown in FIG. 1, inputs of hasher combinatorial cone 150 are grouped into octets and each group of eight inputs is addressable via distribution bus 120. In this manner, parser control module 112 can send a byte of data extracted from a packet to any of the octet input groups of compaction array 140. As shown, compaction array 140 comprises sixteen octet input groups and can therefore receive sixteen bytes from parser 110 and pass the same number on to hasher combinatorial cone 150.

Four bytes of the total of sixteen bytes available at inputs of hasher combinatorial cone 150 are generally reserved for a given IP address, e.g., a source (i.e., first section 210) or destination (i.e., fourth section 240). In the case of an IPv6 address, which as described above requires sixteen bytes, four bytes is insufficient. As described in more detail herein, by sequentially feeding parts of an IPv6 address to a same set of inputs of compaction array 140, a compacted identifier is compiled at the corresponding outputs of compaction array 140 so that a whole IPv6 address can be fed, in compacted form, into hasher combinatorial cone 150. With reference again to FIG. 1, the arrival of bytes of data 121 at compaction array 140 (via distribution bus 120) is illustrated. As is shown, while bytes one to four and nine to twelve receive four bytes in sequence, bytes five to eight and thirteen to sixteen only receive one byte each in the same period. While the different compaction modules may be supplied in any order, any module performing a compaction function during a given period should preferably receive each of its bytes one after the after without pause.

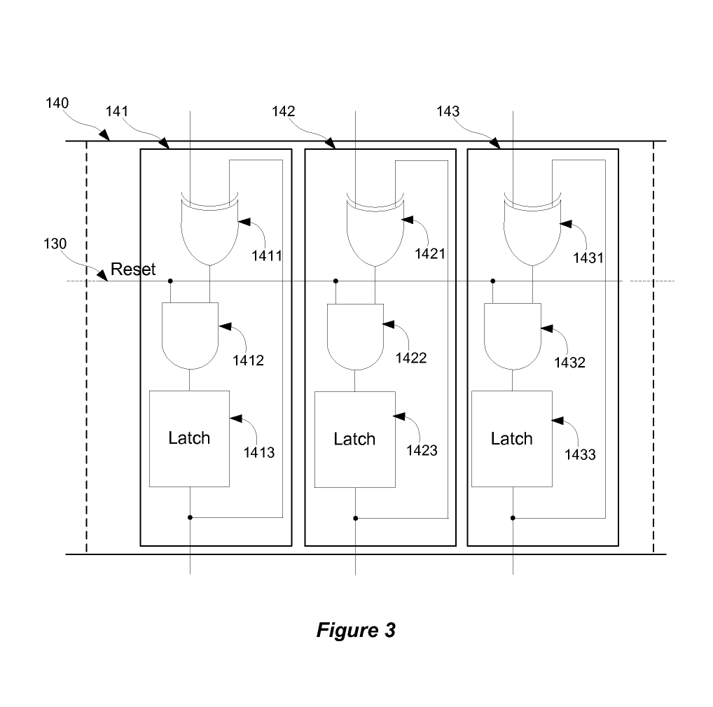

FIG. 3 shows additional details of the components of compaction array 140 in accordance with one embodiment. In various embodiments, compaction array 140 sequentially receives parts of a binary identifier by applying an exclusive OR (XOR) function to each bit of the result of a preceding XOR function, respectively, with each new bit (until no new bits are received). Accordingly, compaction array 140 incorporates array compactor modules each comprising an XOR gate 1411, 1421, 1431, each of which receives inputs from distribution bus 120 on one input and the result of the preceding calculation as stored at a respective latch 1413, 1423, 1433 on another input. Each time a new input is received, the new input is XORed with the result of the previous calculation, and so on. In general, the number of compactor modules in compaction array 140 is equal to the number of bits that hasher combinatorial cone 150 can receive as inputs.

It should be noted that while the structure shown allows the compaction of a series of input values for a given compaction module, in a case where only one input value is received (if the initial value from each latch 1413, 1423, 1433 is 0), the result of the XOR function written to each latch 1413, 1423, 1433 will be equal to the input value. This feature is controlled via reset line 130, which is connected to one input of a respective AND gate 1412, 1422, 1432 situated in each compaction module, so as to AND together the value on reset line 130 and the output of the respective XOR gate, and provide the result as an input to each latch 1413, 1423, 1433. In this manner, by setting the value on reset line 130 to 0, the output of each AND gate 1412, 1422, 1432 is set to 0 and each latch 1413, 1423, 1433 value is also then set to 0 so that the next value received at the input of any compaction module is transmitted faithfully to its output (and on to hasher combinatorial cone 150) without modification. By way of example, the above-described approach is applied to the binary identifier of Table 1.

TABLE 1

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 0 | 0 | 0 | 1 | 1 | 1 | 0 | 0 | 1 | 0 | 0 | 1 | 1 | 1 | 0 | 1 | 1 | 1 | 1 | 0 | 1 | 1 | 1 | 1 | 1 | 1 | 0 | 0 | 0 | 0 | 1 0 |
| 0 | 0 | 1 | 1 | 0 | 1 | 1 | 1 | 1 | 0 | 0 | 0 | 1 | 0 | 1 | 1 | 0 | 0 | 1 | 1 | 1 | 1 | 1 | 1 | 0 | 0 | 0 | 0 | 0 | 0 | 1 0 |
| 0 | 0 | 0 | 0 | 0 | 0 | 0 | 0 | 1 | 0 | 1 | 1 | 0 | 1 | 0 | 1 | 0 | 1 | 1 | 0 | 0 | 1 | 1 | 0 | 0 | 0 | 0 | 1 | 0 | 0 | 1 1 |
| 1 | 1 | 1 | 1 | 0 | 1 | 0 | 1 | 1 | 1 | 1 | 0 | 0 | 1 | 1 | 1 | 0 | 0 | 1 | 1 | 1 | 1 | 1 | 1 | 0 | 0 | 0 | 1 | 0 | 1 | 0 0 |

The binary identifier includes sixteen octets and, as such, corresponds to a standard IPv6 address, although the actual values are random and may not correspond to a valid address. In accordance with the foregoing, the sixteen octets are split into four parts. A first part (Part 1), corresponding to the first row of Table 1, is XORed bitwise with a start-up value of zero. A first partial result (as stored in the latches 1413, 1423, 1433, etc.) after the first cycle is shown in Table 2 below.

TABLE 2

| | Byte A | Byte B | Byte C | Byte D |
|---|---|---|---|---|
| Start-up | 0 0 0 0 0 0 0 0 | 0 0 0 0 0 0 0 0 | 0 0 0 0 0 0 0 0 | 0 0 0 0 0 0 0 0 |
| Part 1 | 0 0 0 1 1 1 0 0 | 1 0 0 1 1 1 0 1 | 1 1 1 0 1 1 1 1 | 1 1 0 0 0 0 1 0 |
| Partial result | 0 0 0 1 1 1 0 0 | 1 0 0 1 1 1 0 1 | 1 1 1 0 1 1 1 1 | 1 1 0 0 0 0 1 0 |

Next, a second part (Part 2), corresponding to the second row of Table 1, is XORed bitwise with the result of the preceding (first) cycle (as stored in the latches 1413, 1423, 1433, etc.) to provide a second partial result as shown in Table 3 below.

TABLE 3

| | Byte A | Byte B | Byte C | Byte D |
|---|---|---|---|---|
| First Partial result | 0 0 0 1 1 1 0 0 | 1 0 0 1 1 1 0 1 | 1 1 1 0 1 1 1 1 | 1 1 0 0 0 0 1 0 |
| Part 2 | 0 0 1 1 0 1 1 1 | 1 0 0 0 1 0 1 1 | 0 0 1 1 1 1 1 1 | 0 0 0 0 0 0 1 0 |
| Second Partial result | 0 0 1 0 1 0 1 1 | 0 0 0 1 0 1 1 0 | 1 1 0 1 0 0 0 0 | 1 1 0 0 0 0 0 0 |

Then, the third part (Part 3), corresponding to the third row of Table 1, is XORed bitwise with the result of the preceding (second) cycle (as stored in latches 1413, 1423, 1433, etc.) to provide a third partial result as shown in Table 4 below.

TABLE 4

| | Byte A | Byte B | Byte C | Byte D |
|---|---|---|---|---|
| Second Partial result | 0 0 1 0 1 0 1 1 | 0 0 0 1 0 1 1 0 | 1 1 0 1 0 0 0 0 | 1 1 0 0 0 0 0 0 |
| Part 3 | 0 0 0 0 0 0 0 0 | 1 0 1 1 0 1 0 1 | 0 1 1 0 0 1 1 0 | 0 0 0 1 0 0 1 1 |
| Third Partial result | 0 0 1 0 1 0 1 1 | 1 0 1 0 0 0 1 1 | 1 0 1 1 0 1 1 0 | 1 1 0 1 0 0 1 1 |

Finally, the fourth part (Part 4), corresponding to the fourth row of Table 1, is XORed bitwise with the result of the preceding (third) cycle (as stored in the latches 1413, 1423, 1433, etc.) to provide a final result as shown in Table 5 below.

TABLE 5

| | Byte A | Byte B | Byte C | Byte D |
|---|---|---|---|---|
| Third Partial result | 0 0 1 0 1 0 1 1 | 1 0 1 0 0 0 1 1 | 1 0 1 1 0 1 1 0 | 1 1 0 1 0 0 1 1 |
| Part 4 | 1 1 1 1 0 1 0 1 | 1 1 1 0 0 1 1 1 | 0 0 1 1 1 1 1 1 | 0 0 0 1 0 1 0 0 |
| Final Result | 1 1 0 1 1 1 1 0 | 0 1 0 0 0 1 0 0 | 1 0 0 0 1 0 0 1 | 1 1 0 0 0 1 1 1 |

The final result is then processed through hasher combinatorial cone 150.

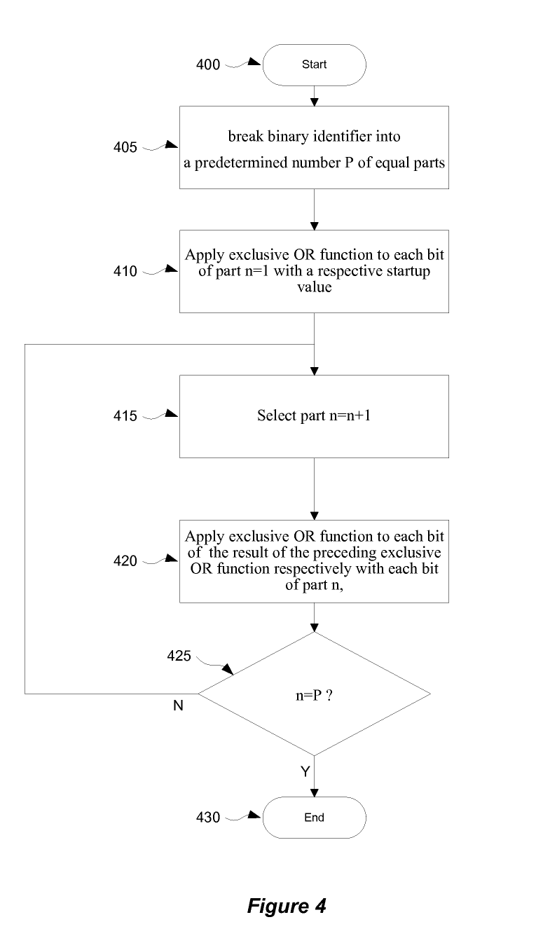

As shown in FIG. 4, a binary identifier compaction process (performed by compaction array 140) is initiated at block 400, before proceeding to block 405. In block 405, a binary identifier, such as an IPv6 address, is broken into a predetermined number ‘P’ of equal parts. For ease of understanding, the process is described in conjunction with FIGS. 1 and 2. An IPv6 address of sixteen bytes is broken into four parts of four bytes each. The process then proceeds to block 410, where an XOR function is applied to each bit of the first part (n=1) with a respective start-up value (in the example of FIG. 3, the start-up value was ‘0’ for all bits). The process then proceeds to block 415, where the next part is selected, i.e. incrementing the value of n. The process then proceeds to block 420, where an XOR function is applied to each bit of the result of the preceding XOR function, respectively, with each bit of the current part.

The process next proceeds to block 425 where it is determined whether any parts remain, i.e., whether n=P. In the case where the last part has been XORed, the process terminates at block 430, where the result of the last XOR function forms the compacted binary identifier. Otherwise the process loops back to block 415. In one or more embodiments, each of the parts comprises a respective sequence of bits retaining the order of a continuous sequence of bits from the original binary identifier. After the completion of the compaction process of FIG. 4, in accordance with the embodiment of FIG. 1, the compacted binary identifier is fed into the hasher combinatorial cone 150. More specifically, as discussed with reference to FIG. 2, the compacted binary identifier is fed into the hasher combinatorial cone 150 together with other packet specific data. In such cases, the binary identifier may be a source IP address and the other packet specific data may incorporate a destination IP address also compacted according to the process of FIG. 4. The disclosed embodiments may be particularly useful in processing a stream of IPv6 packets transported via Ethernet (i.e., encapsulated in Ethernet packets).

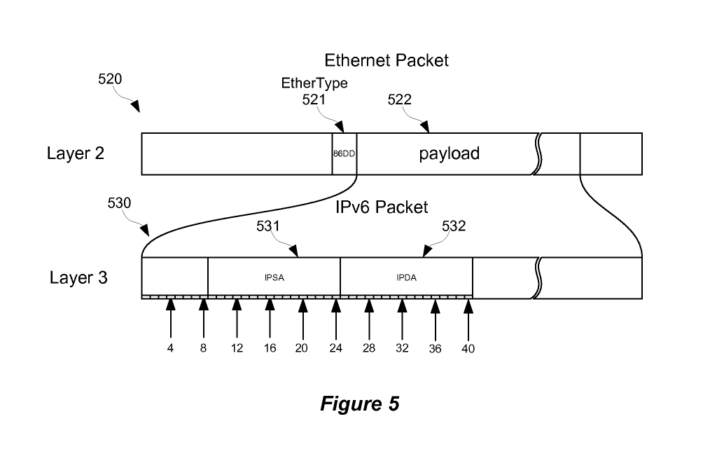

FIG. 5 illustrates parts of an IPv6 packet encapsulated in an Ethernet packet. As shown, an Ethernet (Layer 2) packet 520 includes an EtherType field 521 and payload 522. Payload 522 incorporates an IPv6 (Layer 3) packet 530, which includes a source address field 531 and a destination address field 532. In one or more embodiments, a value of 86DD₁₆ in EtherType field 521 indicates that the Ethernet packet encapsulates an IPv6 packet, which can then be processed as described above.

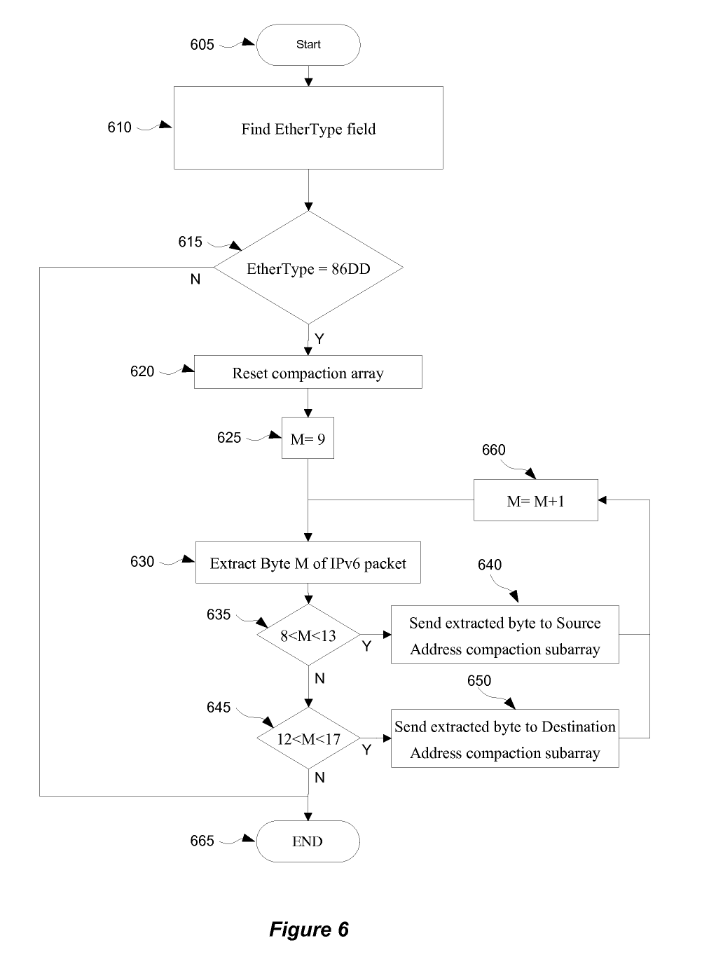

FIG. 6 illustrates a process implemented by parser control module 112 to support data processing in accordance with an embodiment of the present disclosure. The process starts at block 605, before proceeding to block 610, where parser control module 112 locates the EtherType field 521 as discussed with respect to FIG. 5. At block 615, the parser control module 112 determines whether the value in the EtherType field 521 is 86DD₁₆. In the case where the value in the EtherType field 521 is not 86DD₁₆, the process terminates at block 665. Otherwise the process proceeds to block 620 where the value on reset line 130 is set to zero, thereby setting the values in each of latches 1413, 1423, 1433 in compaction array 140 to zero as described with respect to FIG. 3.

Thereafter, at block 635 a value ‘M’ is set to ‘9’, and at block 625 the Mth byte of the IPV6 address is extracted from the packet in registers 111. At block 635 parser control module 112 determines whether the value of ‘M’ is between ‘8’ and ‘13’, in which case the extracted byte is sent to section 210 of compaction array 140 reserved for source addresses at block 640. If at block 635 it is determined that the value of M is not between ‘8’ and ‘13’, at block 645 parser control module 112 determines whether the value of ‘M’ is between ‘12’ and ‘17’, in which case the extracted byte is sent to section 240 of compaction array 140 reserved for destination addresses at block 650.

If at block 635 parser control module 112 determines that the value of ‘M’ is not between ‘12’ and ‘17’, the process terminates at block 665. After either block 640 or 650 the process proceeds to block 660, where ‘M’ is incremented by one before looping back to block 630. It will be appreciated that the blocks may be carried out in different orders without modifying the overall effect of identifying the presence of an IPv6 packet, extracting the address fields, and sending the fields to the appropriate parts of compaction array 140.

Accordingly, a hasher been disclosed herein that advantageously generates compacted binary identifiers that may be utilized to identify packets for assignment to a packet flow.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” (and similar terms, such as includes, including, has, having, etc.) are open-ended when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of generating a compacted binary identifier, comprising:
breaking, using a parser, an original binary identifier into equal parts;
exclusive ORing, using a compaction array, each bit of a first one of the parts with a start-up value to generate a first result; and
exclusive ORing, using the compaction array, each bit of the first result with a respective bit of a second one of the parts to generate a second result.

2. The method of claim 1, further comprising:
exclusive ORing, using the compaction array, each bit of the second result with a respective bit of a third one of the parts to generate a third result; and
exclusive ORing, using the compaction array, each bit of the third result with a respective bit of a fourth one of the parts to generate a fourth result that forms the compacted binary identifier.

3. The method of claim 2, wherein the original binary identifier is an IP address.

4. The method of claim 2, wherein the original binary identifier is extracted from an IP packet.

5. The method of claim 2, wherein the original binary identifier is an IPv6 address of 128-bits, the original binary identifier is split into four parts each of 32-bits, and the compacted binary identifier corresponds to an IPv4 address of 32-bits.

6. The method of claim 2, wherein the start-up value is 0.

7. The method of claim 2, wherein each of the parts includes a respective sequence of bits that retain an order of a continuous sequence of bits from the original binary identifier.

8. The method of claim 2, further comprising:
feeding, from the compaction array, the compacted binary identifier into a hasher combinatorial cone.

9. The method of claim 8, wherein the compacted binary identifier is fed into the hasher combinatorial cone together with other packet specific data.

10. The method of claim 9, wherein the original binary identifier is a source IP address and the other packet specific data includes a compacted destination IP address.

11. A hasher configured to generate a compacted binary identifier, the hasher comprising:
a parser configured to break an original binary identifier into equal parts; and
a compaction array coupled to the parser, wherein the compaction array is configured to:
exclusive OR each bit of a first one of the parts with a start-up value to generate a first result; and
exclusive OR each bit of the first result with a respective bit of a second one of the parts to generate a second result.

12. The hasher of claim 11, wherein the compaction array is further configured to:
exclusive OR each bit of the second result with a respective bit of a third one of the parts to generate a third result; and
exclusive OR each bit of the third result with a respective bit of a fourth one of the parts to generate a fourth result that forms the compacted binary identifier.

13. The hasher of claim 12, wherein the original binary identifier is an IP address.

14. The hasher of claim 12, wherein the original binary identifier is extracted from an IP packet.

15. The hasher of claim 12, wherein the original binary identifier is an IPv6 address of 128-bits, the original binary identifier is split into four parts each of 32-bits, and the compacted binary identifier corresponds to an IPv4 address of 32-bits.

16. The hasher of claim 12, wherein the start-up value is 0.

17. The hasher of claim 12, wherein each of the parts includes a respective sequence of bits that retain an order of a continuous sequence of bits from the original binary identifier.

18. A hasher, comprising:
a parser configured to break an original binary identifier into equal parts;
a compaction array coupled to the parser, wherein the compaction array is configured to:
exclusive OR each bit of a first one of the parts with a start-up value to generate a first result;
exclusive OR each bit of the first result with a respective bit of a second one of the parts to generate a second result;
exclusive OR each bit of the second result with a respective bit of a third one of the parts to generate a third result; and
exclusive OR each bit of the third result with a respective bit of a fourth one of the parts to generate a fourth result that forms the compacted binary identifier; and
a hasher combinatorial cone coupled to the compaction array, wherein the hasher combinatorial cone is configured to hash the compacted binary identifier.

19. The hasher of claim 18, wherein the original binary identifier is an IP address.

20. The hasher of claim 18, wherein the original binary identifier is extracted from an IP packet.
